(19) United States
(12) Patent Application Publication
(10) Pub. No.: US 2015/0324657 A1
(43) Pub. Date: Nov. 12, 2015

(54) METHOD AND APPARATUS FOR MEASURING 3D SHAPE BY USING DERIVATIVE MOIRE

(71) Applicants: ChoonSik Cho, Seoul (KR); JooHwan KIM, Seoul (KR); Fibertec Co., Ltd., Seoul (KR)

(72) Inventors: ChoonSik Cho, Seoul (KR); YoonJae BAE, Ulsan (KR); ByeongWan HA, Goyang (KR); JiAn PARK, Seongnam (KR); JooHwan KIM, Seoul (KR)

(21) Appl. No.: 14/299,079

(22) Filed: Jun. 9, 2014

(30) Foreign Application Priority Data
May 8, 2014 (KR) 10-2014-0055083

(51) Int. Cl. G06K 9/46; G06K 9/52

(52) U.S. Cl. CPC G06K 9/46; G06K 9/52

(57) ABSTRACT

The present disclosure provides an apparatus for measuring three-dimensional shapes by using moire interference, which comprises a unit calibration unit, an integrated calibration unit and a phase calibration unit. The unit calibration unit is configured to use a phase difference between two adjacent measuring points for obtaining a unit calibration value of an absolute moire order. The integrated calibration unit is configured to calibrate the absolute moire order up to a target point by using the unit calibration values. The phase calibration unit is configured to calibrate a phase of the target point by using the absolute moire order.

### RELATED APPLICATIONS

The present application is based on, and claims priority from, Korean Patent Application Number 10-2014-0055083, filed May 8, 2014, the disclosure of which is hereby incorporated by reference herein in its entirety.

### TECHNICAL FIELD

The present disclosure in some embodiments relates to a method and an apparatus for measuring three-dimensional shapes by using derivative moire. More particularly, the present disclosure relates to an improved measurement method and apparatus thereof made to overcome the 2π ambiguity of moire interferometry or moire interference.

### BACKGROUND

The statements in this section merely provide background information related to the present disclosure and may not constitute prior art.

3D shape measurement is a technical field that has attracted a lot of attention recently. 3D shape measuring technology has remarkably developed thanks to the expansion of industrial applications in the medical, manufacturing and biometric fields and the like.

Representative 3D shape measuring methods include laser scanning, Time of Flight (TOF), stereo vision, and moire interference.

Laser scanning is a method for acquiring the 3D information of an object in such a way as to emit laser light onto an object and observe a change of the shape of the laser light from the side. This method can acquire precise 3D information, but has a slow measuring speed because laser light or an object should be moved.

TOF is a method for acquiring the 3D information of an object in such a way as to emit pulsed light or RF modulated light onto an object and compare the emitted light with reflected light. A pulsed light technique is a method for calculating the distance by measuring the time it takes for light to be emitted from an emitter and returned to the emitter, while an RF modulated light technique is a method for calculating the distance by measuring the phase shift between emitted light and returned light. This method has a fast measuring speed, but suffers from low precision because light is distorted or scattered while it propagates between an emitter and an object.

Stereo vision uses the principle by which a human feels the three dimensional effect of an object by using his or her both eyes, and is a method for acquiring the 3D information of an object in such a way as to photograph the same object by using two cameras and then compare the two acquired images. This method can acquire the 3D information of an object in a relatively inexpensive and simple manner, but is disadvantageous in that it is difficult to measure a distant object and that an algorithm for searching the matching point between two images is complicated.

As a result, a 3D shape measuring method that has attracted is moire interference. Moire interference is a method for acquiring the 3D information of an object in such a way as to project a reference grating having a specific grid onto an object and then observe a moire pattern generated when a deformed grating is overlaid on the reference grating.

Moire interference enables faster and more efficient 3D shape measurement than other measuring methods. In spite of this, the application of moire interference in the actual industry fields is sluggish because of two limitations of moire interference.

The first limitation is that a phase acquired by moire interference is not clear because of noise, and the second limitation is that a measuring error called “2π ambiguity” occurs during phase unwrapping.

As to the first limitation, noise can be illuminated by using “cosine transform”, “wavelet transform” or the like. However, as to the second limitation, there is no reliable solution. Although a method for overcoming the problem of 2π ambiguity by using a “least square method” has been proposed, the “least square method” requires complicated computation and cannot appropriately reflect a rapid change of phase.

### SUMMARY

In accordance with some embodiments, the present disclosure provides an apparatus for measuring three-dimensional shapes by using moire interference, which comprises a unit calibration unit, an integrated calibration unit and a phase calibration unit. The unit calibration unit may be configured to use a phase difference between two adjacent measuring points for obtaining a unit calibration value of an absolute moire order. The integrated calibration unit may be configured to calibrate the absolute moire order up to a target point by using the unit calibration values. The phase calibration unit may be configured to calibrate a phase of the target point by using the absolute moire order.

In accordance with some embodiments, the present disclosure provides a method for measuring three-dimensional shapes by using moire interference, comprising performing a unit calibration by using a phase difference between two adjacent measuring points to obtain a unit calibration value of an absolute moire order; performing an integrated calibration by calibrating the absolute moire order up to a target point by using the unit calibration values; and calibrating a phase of the target point by using the absolute moire order.

### BRIEF DESCRIPTION OF DRAWINGS

FIG. 1 is a diagram of a moire pattern.

FIG. 2 is a diagram of the principle of projection moire interference.

FIG. 3 is a diagram of the 2π ambiguity of moire interference.

FIG. 4 is a diagram of the principle of phase shifting moire interference.

FIG. 5 is a block diagram of a 3D shape measuring apparatus using derivative moire.

FIG. 6 is a flowchart of a 3D shape measuring method using derivative moire.

FIG. 7 is a picture of a subject of a test for validating an exemplary embodiment of the present disclosure.

FIGS. 8 to 11 are diagrams of deformed gratings acquired by using a phase shifting moire interference in tests that were conducted to validate the embodiment of the present disclosure.

FIG. 12 is a diagram of a moire pattern generated when a deformed grating acquired by using a phase shifting moire interference in tests that were conducted to validate the embodiment was overlaid on a reference grating.

FIG. 13 is a diagram of a result obtained by differentiating the moire pattern generated by using a phase shifting moire interference in tests that were conducted to validate the embodiment was overlaid on the reference grating, along the x-axis direction.

FIG. 14 is a diagram of a result obtained by differentiating the moire pattern generated by using a phase shifting moire interference in the tests that were conducted to validate the embodiment was overlaid on the reference grating, along the y-axis direction.

FIG. 15 is a diagram of a final 3D shape acquired by using an absolute moire order calculated by using derivative moire in the tests that were conducted to validate the embodiment.

REFERENCE NUMERALS

| | |
|---|---|
| 110: Reference Grating | 120: Deformed Grating |
| 130: Moire Pattern | 211: Projection System |
| 213: Imaging System | 220: Subject of Measurement |
| 310: Actual Height of Subject | |

321: Phase of Moire Pattern When n = 1
323: Phase of Moire Pattern When n = 0
325: Phase of Moire Pattern When n = −1
327: Phase of Moire Pattern When n = −2

| | |
|---|---|
| 410: Light Source | |
| 420: Condenser Lens | 430: Reference Mirror |
| 440: Subject of Measurement | 450: Spectrometer |
| 460: Moire Pattern | 500: Derivative Moire Computing Unit |
| 510: Unit Calibration Unit | 511: Unit Derivative Computing Unit |

513: Unit Absolute Moire Order Computing Unit

| | |
|---|---|
| 520: Integrated Calibration Unit | 521: First Calibration Unit |
| 523: First Computing Unit | 525: Second Calibration Unit |
| 527: Second Computing Unit | 530: Phase Calibration Unit |
| 550: Phase Measuring Unit | 570: Phase Output Unit |

### DETAILED DESCRIPTION

The present disclosure in some embodiments provides a method and an apparatus for measuring three-dimensional shapes by using derivative moire, which are improved over conventional methods to quickly and accurately and resolve the 2π ambiguity of moire interferometry.

Hereinafter, at least one embodiment of the present disclosure will be described in detail with reference to the accompanying drawings. In the following description, like reference numerals designate like elements although the elements are shown in different drawings. Further, in the following description of the at least one embodiment, a detailed description of known functions and configurations incorporated herein will be omitted for the purpose of clarity and for brevity.

Additionally, in describing the components of the present disclosure, terms like first, second, i), ii), a) and b) are used. These are solely for the purpose of differentiating one component from another, and one of ordinary skill would understand the terms are not to imply or suggest the substances, order or sequence of the components. If any component is described as “comprising” or “including” another component, this implies that the former component includes other components rather than excluding other components unless otherwise indicated herein or otherwise clearly contradicted by context. Furthermore, the terms “unit” and “module” each refer to a unit that processes at least one function or operation, and may be implemented by using “hardware”, “software” or “a combination of hardware and software.”

This embodiment relates to a measurement method and apparatus for overcoming 2π ambiguity that inevitably occurs in moire interference.

2π ambiguity is a problem that occurs because a moire pattern has the form of a cosine function. It is impossible to acquire accurate 3D information by using only information that is provided by moire patterns because of 2π ambiguity.

Up to now, many methods for overcoming 2π ambiguity have been proposed. However, these methods are insufficient to completely overcome 2π ambiguity or are excessively complicated. This embodiment provides a measurement method and apparatus that conveniently and efficiently overcome the 2π ambiguity by differentiating the phase of a moire pattern, unlike the conventional methods.

This embodiment uses a differential operation, and thus the measurement method and apparatus according to this embodiment is referred to as “derivative moire”.

A understanding of 2π ambiguity is a prerequisite for a understanding of the principle of this embodiment. i) Moire interference, ii) projection moire interference, iii) 2π ambiguity of projection moire interference, iv) phase shifting moire interference, and v) 2π ambiguity of phase shifting moire interference will be described in brief, and then derivative moire will be described in detail, as follows:

1. Moire Interference

A moire pattern is a pattern that is generated when patterns having a specific interval are overlaid on each other, as in overlaid silks or overlaid mosquito nets. When patterns having similar periods are overlaid, a unique pattern is generated by the beating effect. This pattern is referred to as a “moire pattern.”

A moire pattern has various characteristics. Of these characteristics, the characteristics to which engineers pay attention are that a moire pattern represents the motion of an object in a considerably amplified manner and that a moire pattern has 3D information of an object. By using these characteristics, it is possible to perform the analysis of the micromotion of an object or the measurement of the 3D shape of an object.

When two lights emitted from the same point propagate along different paths, an interference fringe is generated. The generated interference fringe is caused by the difference of the paths of lights. Accordingly, when the interference fringe is known, the distance from a light source to the interference fringe can be calculated in a reverse manner. A moire pattern is a kind of interference fringe, so the distance from a light source to the surface of an object can be acquired by using a similar manner.

A moire pattern is acquired by moire interference. Moire interference is classified into shadow moire interference and projection moire interference.

2. Projection Moire Interference

Projection moire interference is a method that projects a reference grating pattern onto a subject of measurement and observes a moire pattern generated when a deformed grating is overlaid on the reference grating are overlaid on the subject of measurement. By using projection moire interference, it is possible to measure a large-sized object. Accordingly, commonly used moire interference is projection moire interference. This embodiment also employs projection moire interference.

To measure the 3D shape of an object by using projection moire interference, a reference grating needs to be projected onto the object. The projected grating is deformed depending on the shape of the object. When the deformed grating is overlaid on the reference grating, a moire pattern appears. The moire pattern generated appears like contour lines, and thus the flatness of the object can be determined by analyzing the moire pattern.

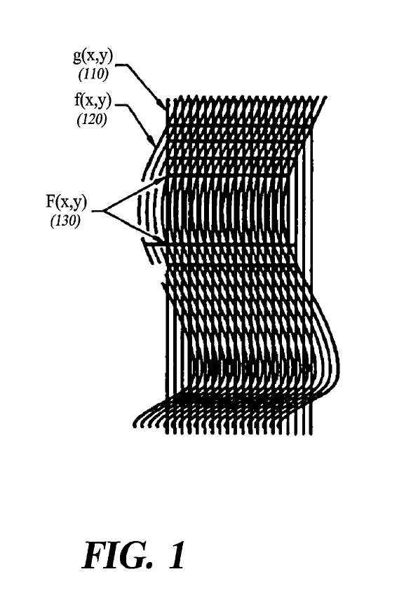

FIG. 1 is a diagram of a moire pattern moire pattern.

Referring to FIG. 1, when a vertically straight reference grating 110 is projected onto an object, a deformed grating 120 appears on the surface of the object along the contour of the object. When the deformed grating 120 is overlaid on the reference grating 110, a lateral line that has not been present before is generated. This lateral line is a moire pattern 130.

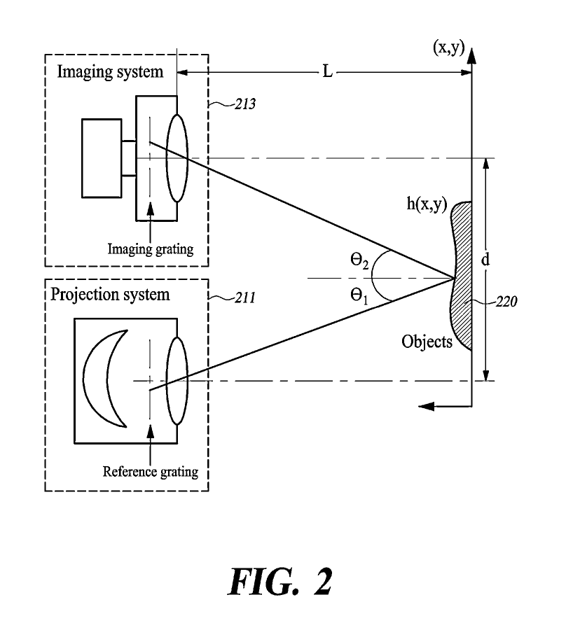

FIG. 2 is a diagram of the principle of projection moire interference.

A projection system 211 projects a reference grating onto the surface of a subject of measurement 220. The reference grating is deformed on the surface of the subject of measurement 220, and the deformed grating is overlaid on the reference grating in an imaging system 213, thereby forming a moire pattern.

3. 2π Ambiguity of Projection Moire Interference

When a grating with the pitch G is projected by using a projection system with the magnification M, a deformed grating at a measuring point x on the surface of an object has the intensity of light, as expressed by Equation 1:

$${I}_{1} ( x , y ) = {I}_{source} RA [ 1 + cos ( \frac{2 π ( r ( x , y ) + h ( x , y ) tan {θ}_{1}}{MG} ) ] \qquad Equation 1$$

In Equation 1, I₁(x, y) is the intensity of light of the deformed grating, I_{source} is the intensity of a light source, R is the reflectance of the surface of the object, A is the modulation of the grating, r(x, y) is the distance to the measuring point (x, y), h(x, y) is the height of the measuring point (x, y), θ₁ is the angle of the projection system with respect to the measuring point (x, y), M is the magnification of the projection system, and G is the pitch of the grating.

The deformed grating is reflected from the surface of the object and then is overlaid on the reference grating of the imaging system, thereby forming a moire pattern. For ease of analysis, it may be assumed that the reference grating is projected from the imaging system to the surface of the object. In this case, the reference grating has the intensity of light on the surface of the object, as expressed by Equation 2:

$${I}_{2} ( x , y ) = A [ 1 + cos ( \frac{2 π ( r ( x , y ) + h ( x , y ) tan {θ}_{2}}{MG} ) ] \qquad Equation 2$$

In Equation 2, I₂(x, y) is the intensity of light of the reference grating, A is the modulation of the grating, r(x, y) is the distance to the measuring point (x, y), h(x, y) is the height of the measuring point (x, y), θ₂ is the angle of the imaging system with respect to the measuring point (x, y), M is the magnification of the projection system, and G is the pitch of the grating.

An image formed in such a manner that the deformed grating is overlaid on the reference grating has the intensity of light, as expressed by Equation 3:

I(x,y)=I₁(x,y)×I₂(x,y) Equation 3

In Equation 3, I(x, y) is the intensity of light of the overlaid image, I₁(x, y) is the intensity of light of the deformed grating, and I₂(x, y) is the intensity of light of the reference grating.

Equation 4 is obtained by expanding Equation 3:

$$I ( x , y ) = {I}_{source} {RA}^{2} + {I}_{source} {RA}^{2} cos ( \frac{2 π ( r ( x , y ) + h ( x , y ) tan {θ}_{1} )}{MG} ) + {I}_{source} {RA}^{2} cos ( \frac{2 π ( r ( x , y ) + h ( x , y ) tan {θ}_{2} )}{MG} ) + {I}_{source} {RA}^{2} \{ cos ( \frac{2 π ( r ( x , y ) + h ( x , y ) tan {θ}_{1} )}{MG} ) cos ( \frac{2 π ( r ( x , y ) + h ( x , y ) tan {θ}_{2} )}{MG} ) \} \qquad Equation 4$$

In Equation 4, I(x, y) is the intensity of light of the overlaid image, I_{source} is the intensity of the light source, R is the reflectance surface of the object, A is the modulation of the grating, r(x, y) is the distance to the measuring point (x, y), h(x, y) is the height of the measuring point (x, y), θ₁ is the angle of the projection system with respect to the measuring point (x, y), θ₂ is the angle of the imaging system with respect to the measuring point (x, y), M is the magnification of the projection system, and G the pitch of the grating.

Furthermore, in Equation 4, the first term represents the background image of the overall image, the second term represents an image of the deformed grating, the third term represents an image of the reference grating, and the fourth term represents an image by the interference between the two gratings.

Equation 5 is obtained by expanding the fourth term and then arranging only terms corresponding to the moire pattern.

$${I}_{moire} ( x , y ) = {I}_{source} {RA}^{2} [ 1 + cos ( \frac{2 π h ( x , y ) ( tan {θ}_{1} - tan {θ}_{2} )}{MG} ) ] \qquad Equation 5$$

In Equation 5, Iₘₒᵢᵣₑ(x, y) is the intensity of the moire pattern of the measuring point (x, y), I_{source} is the intensity of the light source, R is the reflectance of the surface of the object, A is the modulation of the grating, h(x, y) is the height of the measuring point (x, y), θ₁ is the angle of the projection system with respect to the measuring point (x, y), θ₂ is the angle of the imaging system with respect to the measuring point (x, y), M is the magnification of the projection system, and G is the pitch of the grating.

As can be seen from Equation 5, the moire pattern has the form of a cosine function. The phase Φ of the moire pattern is expressed by Equation 6:

$$Φ ( x , y ) = \frac{2 π h ( x , y ) ( tan {θ}_{1} - tan {θ}_{2} )}{MG} \qquad Equation 6$$

In Equation 6, I(x, y) is the phase of the moire pattern generated at the measuring point (x, y), h(x, y) is the height of the measuring point (x, y), θ₁ is the angle of the projection system with respect to the measuring point (x, y), θ₂ is the angle of the imaging system with respect to the measuring point (x, y), M is the magnification of the projection system, and G is the pitch of the grating.

Equation 7 is established by applying a trigonometric function to the lateral distance respecting the surface of the object:

$$tan {θ}_{1} - tan {θ}_{2} = \frac{d}{L - h ( x , y )} \qquad Equation 7$$

In Equation 7, θ₁ is the angle of the projection system with respect to the measuring point (x, y), θ₂ is the angle of the imaging system with respect to the measuring point (x, y), d is the interval between the projection system and the imaging system, L is the distance between the projection system and the baseline, and h(x, y) is the height of the measuring point (x, y).

Equation 8 is obtained by arranging Equations 6 and 7 in the form of simultaneous equations:

$$Φ ( x , y ) = \frac{2 π d}{MG} \times \frac{h ( x , y )}{L - h ( x , y )} \qquad Equation 8$$

In Equation 8, Φ(x, y) is the phase of moire pattern formed at the measuring point (x, y), d is the interval between the projection system and the imaging system, M is the magnification of the projection system, G is the pitch of the grating, L is the distance between the projection system and a baseline, and h(x, y) is the height of the measuring point (x, y).

Since the moire pattern appears in the form of a cosine function, the phase of the moire pattern repeats itself in periods of 2π. Accordingly, Equation 8 needs to be expressed more accurately as Equation 9:

$${Φ}^{0} ( x , y ) + 2 π n = \frac{2 π d}{MG} \times \frac{h ( x , y )}{L - h ( x , y )} \qquad Equation 9$$

In Equation 9, Φ⁰ is the current phase of the moire pattern, n is absolute moire order, d is the interval between the projection system and the imaging system, M is the magnification of the projection system, G is the pitch of the grating, L is the distance between the projection system and the baseline, and h(x, y) is the height of the measuring point (x, y).

The absolute moire order n has the information about the number of periods of 2π that the current phase Φ⁰ of the moire pattern has undergone. Since accurate height cannot be measured only by knowing the current phase Φ⁰ of the moire pattern, the absolute moire order n of the measuring point needs to be known.

When it is impossible to know the absolute moire order n of the measuring point, the phase can be calculated by using the phase difference between two adjacent measuring points.

When the two measuring points are very close to each other, the phase difference between the two measuring points may be smaller than 2π. And when the phase difference between the two adjacent measuring points is smaller than 2π, the phase of an adjacent measuring point may be calculated by adding the phase difference to a measuring point whose phase is known. A scheme of calculating the phase of a measuring point by using the above method is referred to as “phase unwrapping.”

However, since phase unwrapping is based on the assumption that a change in phase between two adjacent measuring points is smaller than 2π, a measurement error occurs when a change in phase between two adjacent measuring points is larger than 2π. This is called “2π ambiguity.”

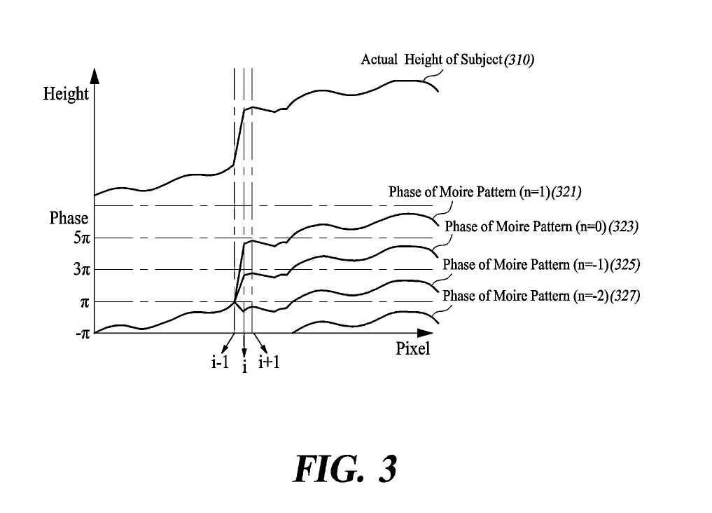

FIG. 3 is a diagram of the 2π ambiguity of moire interference.

Referring to FIG. 3, the height 310 of a subject of measurement sharply increases between two adjacent measuring points i−1 and i. As a result, a change in the phase of a moire pattern between the measuring points i−1 and i exceeds 2π. Since a change in phase larger than 2π cannot be determined by using only a moire pattern, the height 323 of the measuring point calculated by using only a moire pattern is different from an actual height.

In this case, the phase of the measuring point i needs to be calibrated by using the absolute moire order n. In FIG. 3, the absolute moire order used to calibrate the phase of the measuring point i is n=1. Accordingly, when n=1 is applied, a correct phase 321 can be acquired.

If an absolute moire order is incorrectly calculated, an incorrect phase is acquired. For example, it can be seen that a phase 325 obtained by applying n=−1 or a phase 327 obtained by applying n=−2 do not appropriately reflect the actual heights of the subject of measurement.

When the absolute moire order n is known, a correct phase can be acquired even though a change in phase between two adjacent measuring points exceeds 2π. However, it is difficult to acquire the absolute moire order n. Up to now, an accurate solution to the acquisition of the absolute moire order n has not been proposed.

4. Phase Shifting Moire Interference

In phase shifting moire interference having been widely used recently, 2π ambiguity is problematic.

General moire interference is unsuitable for precise measurement due to its low resolution. A technology developed to increase the resolution of moire interference is phase shifting moire interference.

Phase shifting moire interference is a method that mounts a fine actuator, acquires interference signals while moving a reference mirror, and analyzes the interference signals at each measuring point of an image. Phase shifting moire interference is widely used because it is advantageous in that its resolution is high and it can be applied regardless of the shape of a moire pattern.

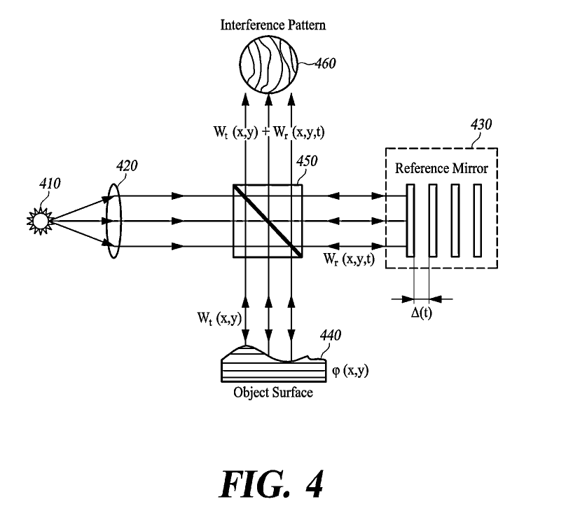

FIG. 4 is a diagram of the principle of phase shifting moire interference.

First, a light source 410 emits light (chiefly, white light) toward a condenser lens 420. Light via the condenser lens reaches a reference mirror 430 and the surface of a subject of measurement 440 through a spectrometer 450. Light reflected from the reference mirror 430 and light reflected from the surface of the subject of measurement 440 reach an imaging system through the spectrometer 450, and form a moire pattern 460.

In phase shifting moire interference, the reference mirror 430 is moved by a fine actuator. When the reference mirror 430 is moved, a phase difference is generated because of an optical path difference. In a commonly used 4-bucket algorithm, the 3D information of a subject of measurement is acquired by acquiring and analyzing the intensities of light at phase differences of 0°, 90°, 180° and 270°.

5. 2π Ambiguity of Phase Shifting More Interference

In phase shifting moire interference, the relationship among the height of a measuring point, the phase of the measuring point, and the length of an equivalent wavelength for projection is expressed by Equation 10:

$$h ( x , y ) = \frac{{λ}_{eq}}{4 π} \times Φ ( x , y ) \qquad Equation 10$$

In Equation 10, h(x, y) is the height of the measuring point (x, y), λ_{eq} is the length of the equivalent wavelength, and Φ(x, y) is the phase of a moire pattern formed at the measuring point (x, y).

In phase shifting moire interference, the phase of the moire pattern appearing at a measuring point P(x, y) is expressed by Equation 11:

$${Φ}^{0} ( x , y ) = {tan}^{- 1} ( \frac{{I}_{1} ( x , y ) - {I}_{3} ( x , y )}{{I}_{4} ( x , y ) - {I}_{2} ( x , y )} ) \qquad Equation 11$$

In Equation 11, Φ⁰ is the current phase of the moire pattern. Furthermore, in phase shifting moire interference, the intensities of light when the phase difference between two gratings sequentially becomes 0°, 90°, 180°, and 270° through phase shift are referred to as I₁(x, y), I₂(x, y), I₃(x, y), and I₄(x, y), respectively.

Since the moire pattern appears in the form of a cosine function, the phase of the moire pattern repeats itself in periods of 2π. Moreover, the phase of a moire pattern acquired through phase shifting moire interference is expressed in the form of an arc-tangent. Since an arc-tangent has only values in the range from −π/2 to π/2, the phase determined through phase shifting moire interference merely ranges from −π/2 to π/2. Accordingly, when phase shifting moire interference is used, the problem of 2π ambiguity occurs if the slope between two adjacent measuring points exceeds π. More specifically, when π is replaced into Φ(x, y) in Equation 10, the problem of 2π ambiguity occurs when the height difference between two adjacent measuring points exceeds λ_{eq}/4.

Referring to Equation 10, when the length of the equivalent wavelength λ_{eq} increases, the measurable height difference between two adjacent points also increases. That is, 2π ambiguity may be prevented by increasing the length of the equivalent wavelength λ_{eq}. However, this method is not widely used because as the length of the equivalent wavelength λ_{eq} increases, the resolution decreases.

In accordance with Equation 11, the phases that can be distinguished by using phase shifting moire interference are in the range of π from −π/2 to π/2. Accordingly, in phase shifting moire interference, the phase of a moire pattern needs to be expressed more accurately as Equation 12:

Φ(x,y)=Φ⁰(x,y)+πn Equation 12

In Equation 12, Φ(x, y) is the phase of a moire pattern formed at a measuring point, Φ⁰ is the current phase of the moire pattern, and n is an absolute moire order.

6. Derivative Moire

A derivative moire technique proposed in this embodiment overcomes the problem of 2π ambiguity by differentiating the phase of the moire pattern to determine a change of an absolute moire order between two adjacent measuring points and then acquiring an absolute moire order based on the change.

This embodiment overcomes the problem of 2π ambiguity by identifying the case where an absolute moire order increases between two adjacent measuring points and the case where an absolute moire order decreases between two adjacent measuring points by using differentiation.

A detailed identification method is expressed by Equation 13:

$$u ( \frac{\partial {Φ}^{0} ( x , y )}{\partial x} {\vert}_{i , j} - {Φ}_{d} ) - u ( - \frac{\partial {Φ}^{0} ( x , y )}{\partial x} {\vert}_{i , j} - {Φ}_{d} ) \qquad Equation 13$$

In Equation 13, u(t) is a function that satisfies u(t)=1 when t≧0 or else u(t)=0, Φ⁰ is the current phase of a moire pattern, and I_{d} (Φ_{discriminant}) is a constant to distinguish whether the absolute moire order is changing or not.

By using Equation 13, the calibration value of an absolute moire order for a current measuring point can be calculated and is referred to as a “unit absolute moire order”. Absolute moire orders with respect to the x axis may be calculated by successively adding “unit absolute moire orders”.

When a target point to be measured is P(i, j), the calibration value of an absolute moire order at the target point may be obtained by fixing the y-axis coordinate to j and then successively adding unit absolute moire orders when the x axis coordinate is 1, 2, 3 . . . and i. This calibration value is called an “integrated absolute moire order with respect to the x axis”. This is expressed by Equation 14:

$${n}_{i , j} = {\sum }_{k = 1}^{i} [ u ( \frac{\partial {Φ}^{0} ( x , y )}{\partial x} {\vert}_{k , j} - {Φ}_{d} ) - u ( - \frac{\partial {Φ}^{0} ( x , y )}{\partial x} {\vert}_{k , j} - {Φ}_{d} ) ] \qquad Equation 14$$

In Equation 14, u(t) is a function that satisfies u(t)=1 when t≧0 or else u(t)=0, is an integrated absolute moire order with respect to the x axis, Φ⁰ is the current phase of a moire pattern, and Φ_{d} (Φ_{discriminant}) is a constant to distinguish whether the absolute moire order is changing or not.

In Equation 14, the value of Φ_{d} may vary depending on a measuring method or a subject of measurement. In order to acquire a correct result, the value of Φ_{d} is experimentally determined. Experiment to acquire the value of Φ_{d} is apparent to those having ordinary knowledge in the art to which the present disclosure pertains.

The value of Φ_{d} is within a range of values larger than 0 and smaller than η. In general, the value of Φ_{d} is very close to π. For example, in experiments measuring the human face, when Φ_{d} was 0.8π, an accurate result was acquired.

The differentiation value of Equation 14 can be calculated by using Equation 15:

$$\frac{\partial {Φ}^{0} ( x , y )}{\partial x} = \frac{{( {I}_{1} - {I}_{3} )}_{x}^{′} ( {I}_{4} - {I}_{2} ) - ( {I}_{1} - {I}_{3} ) {( {I}_{4} - {I}_{2} )}_{x}^{′}}{{( {I}_{1} - {I}_{3} )}^{2} + {( {I}_{4} - {I}_{2} )}^{2}} \qquad Equation 15$$

In Equation 15, Φ⁰ is the current phase of the moire pattern, and I₁(x, y), I₂(x, y), I₃(x, y), and I₄(x, y) are the intensities of light when the phase difference between two gratings sequentially becomes 0°, 90°, 180°, and 270° through phase shift in phase shifting moire interference, respectively.

Phase unwrapping is performed in the x axis direction by using an absolute moire order with respect to the x axis (see Equation 16).

Φ_{i,j}^{x}=Φ_{i,j}⁰+πn_{i,j} Equation 16

In Equation 16, Φ_{i,j}^{x} is a phase on which phase unwrapping has been performed with respect to the x axis, Φ⁰ is the current phase of the moire pattern, and n_{i,j} is an integrated absolute moire order with respect to the x axis.

To obtain the absolute moire order by differentiating the moire pattern, not only the x axis direction but also the y axis direction need to be taken into consideration. In many cases, depending on the shape of an object, there can be no sharp change in slope in the lateral axis (the x axis) but there can be a sharp change in slope in the vertical axis (the y axis). For example, as to the nose and the chin in the human face, there is a gradual change in the lateral axis, but there is a sharp change in the vertical axis. In this case, a correct phase cannot be acquired by phase unwrapping only in the x-axis direction. In this case, phase unwrapping in the y-axis direction is needed.

The absolute moire order with respect to the y axis is calculated as follows.

When a target point to be measured is P(i, j), the calibration value of an absolute moire order at the target point may be obtained by fixing the x-axis coordinate to i and then successively adding unit absolute moire orders when the y axis coordinate is 1, 2, 3 . . . and j. This calibration value is called an “integrated absolute moire order with respect to the y axis”. This is expressed by Equation 17:

$${n}_{i , j}^{x} = {\sum }_{k = 1}^{j} [ u ( \frac{\partial {Φ}^{0} ( x , y )}{\partial y} {\vert}_{i , k} - {Φ}_{d} ) - u ( - \frac{\partial {Φ}^{0} ( x , y )}{\partial y} {\vert}_{i , k} - {Φ}_{d} ) ] \qquad Equation 17$$

In Equation 17, u(t) is a function that satisfies u(t)=1 when t≧0 or else u(t)=0, n_{i,j}^{x} is an absolute moire order with respect to the y axis, Φ⁰ is the current phase of a moire pattern, and Φ_{d} (Φ_{discriminant}) is a constant to distinguish whether the absolute moire order is changing or not.

The differentiation value of Equation 17 can be calculated by using Equation 18:

$$\frac{\partial {Φ}^{0} ( x , y )}{\partial y} = \frac{{( {I}_{1} - {I}_{3} )}_{y}^{′} ( {I}_{4} - {I}_{2} ) - ( {I}_{1} - {I}_{3} ) {( {I}_{4} - {I}_{2} )}_{y}^{′}}{{( {I}_{1} - {I}_{3} )}^{2} + {( {I}_{4} - {I}_{2} )}^{2}} \qquad Equation 18$$

In Equation 18, Φ⁰ is the current phase of the moire pattern, and I₁(x, y), I₂(x, y), I₃(x, y), and I₄(x, y) are the intensities of light when the phase difference between two gratings sequentially becomes 0°, 90°, 180°, and 270° through phase shift in phase shifting moire interference, respectively.

Additional phase unwrapping is performed in the y-axis direction by using the absolute moire order with respect to the y axis (see Equation 19).

Φ_{i,j}=Φ_{i,j}^{x}+πn_{i,j}^{x} Equation 19

In Equation 19, Φ_{i,j} is a phase on which phase unwrapping has been performed with respect the x and y axes, Φ_{i,j}^{x} is a phase on which phase unwrapping has been performed with respect to the x axis, and n_{i,j}^{x} is an absolute moire order with respect to the y axis.

Since the phase acquired by Equation 19 is an accurate phase with no problem of 2π ambiguity, the accurate height can be calculated by using this phase (see Equation 10).

7. 3D Shape Measuring Apparatus Using Derivative Moire

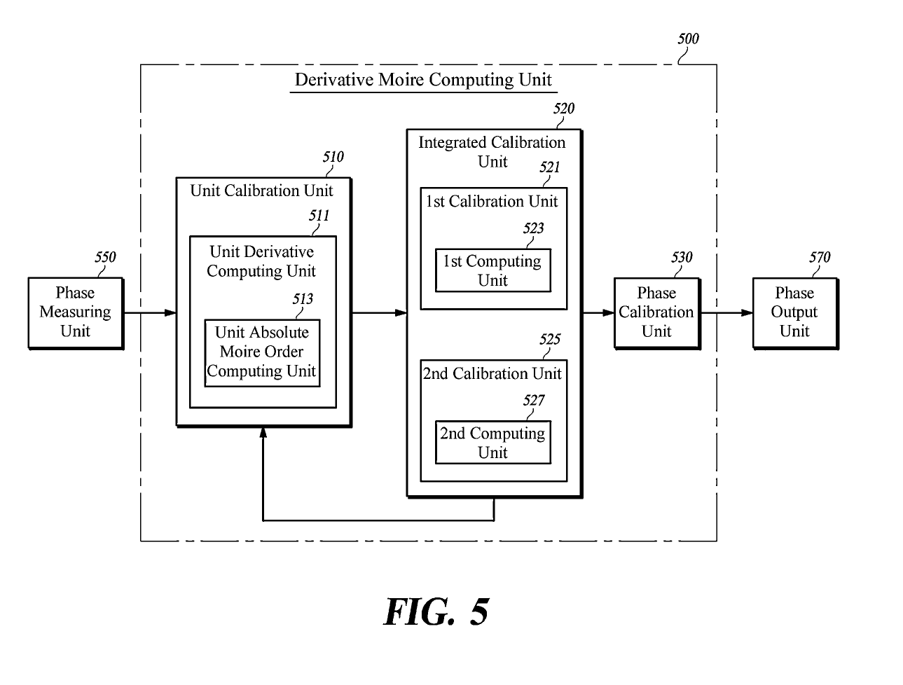

FIG. 5 is a block diagram of a 3D shape measuring apparatus using derivative moire.

The 3D shape measuring apparatus using derivative moire overcomes the problem of 2π ambiguity by installing a derivative moire computation unit 500 between a phase measuring unit 550 and a phase output unit 570.

The derivative moire computation unit 500 includes a unit calibration unit 510, an integrated calibration unit 520, and a phase calibration unit 530.

The unit calibration unit 510 includes a unit derivative computing unit 511. The unit derivative computing unit 511 differentiates the phase of a moire pattern.

The unit derivative computing unit 511 includes a unit absolute moire order computing unit 513. The unit absolute moire order computing unit 513 identifies the change of an absolute moire order.

The integrated calibration unit 520 adds unit absolute moire orders.

The integrated calibration unit 520 includes a 1st calibration unit 521. The 1st calibration unit 521 adds unit absolute moire orders with respect to the x axis.

The 1st calibration unit 521 includes a 1st computing unit 523. The 1st computing unit 523 acquires an integrated absolute moire order with respect to the x axis by using Equation 14.

The integrated calibration unit 520 includes a 2nd calibration unit 521. The 2nd calibration unit 525 adds unit absolute moire orders with respect to the y axis.

The 2nd calibration unit 525 includes a 2nd computing unit 527. The 2nd computing unit 527 acquires an integrated absolute moire order with respect to the y axis by using Equation 17.

The phase calibration unit 530 calibrates the phase of a target point by using a finally acquired integrated absolute moire order.

Since the phase acquired as described above is an accurate phase with no problem of 2π ambiguity, the accurate height can be calculated by using this phase (see Equation 10).

8. 3D Shape Measuring Method Using Derivative Moire

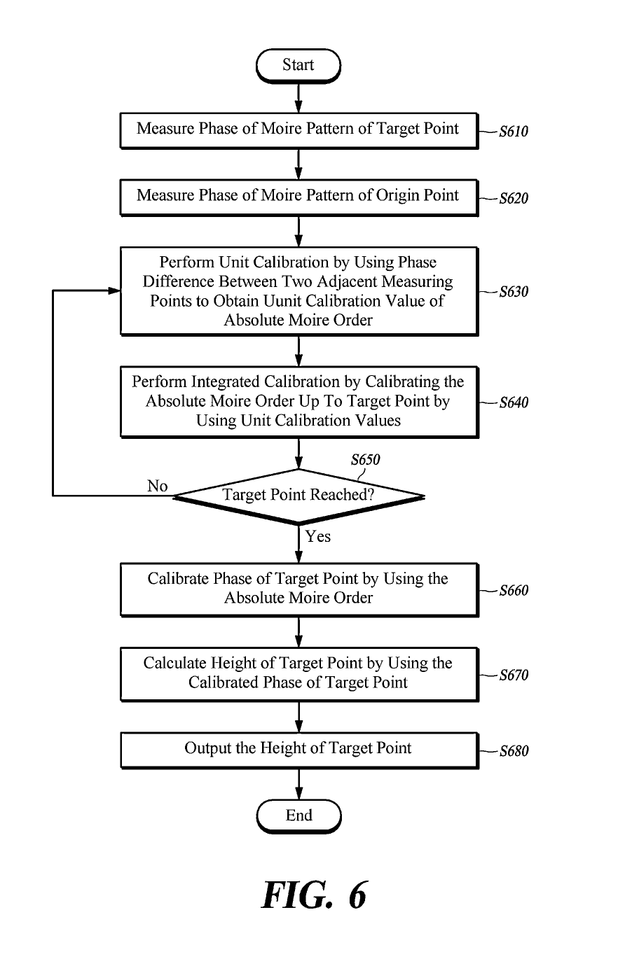

FIG. 6 is a flowchart of a 3D shape measuring method using derivative moire.

The 3D shape measuring method using derivative moire overcomes the problem of 2π ambiguity by adding steps S620 to S670 between step S610 of measuring the phase of a target point and step S680 of outputting the height of the target point.

Step S620 measures the phase of moire pattern of an origin point.

Step S630 performs a unit calibration by using the phase difference between two adjacent measuring points to obtain a unit calibration value of an absolute moire order.

Step S640 performs an integrated calibration by calibrating the absolute moire order up to a target point by using unit calibration values.

Step S650 stops the adding when the target point has been reached, and step S660 calibrates the phase of a target point by using the absolute moire order.

Since the phase acquired as described above is an accurate phase with no problem of 2π ambiguity, the accurate height of a measuring point may be acquired by using this phase (see Equation 10).

9. Validation of Derivative Moire

The following describes the results of the validation of this embodiment.

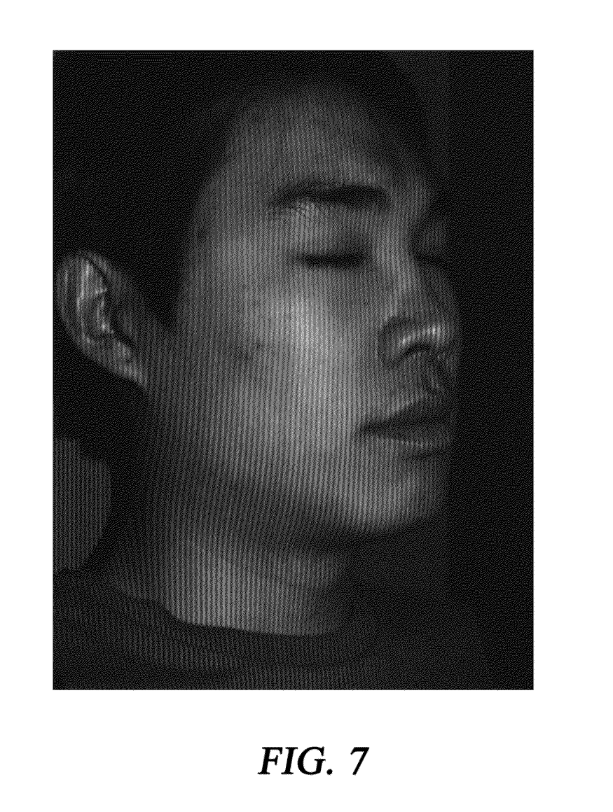

FIG. 7 shows the human face that was a subject of measurement in tests that were conducted to validate an exemplary embodiment of the present disclosure.

The human face that was the subject of measurement was spaced apart from a projection system by 60 cm. The projection system projected a reference grating with pitch of 1 mm and a size of 28 cm×35 cm.

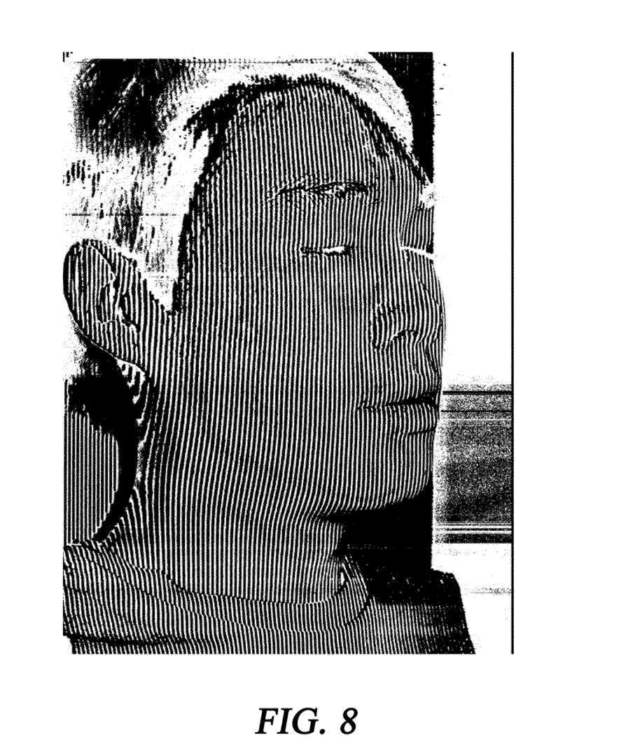

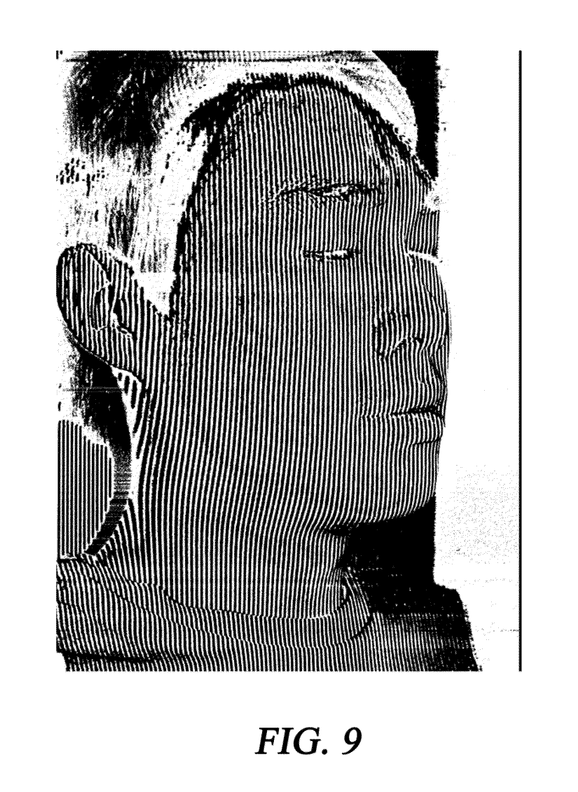

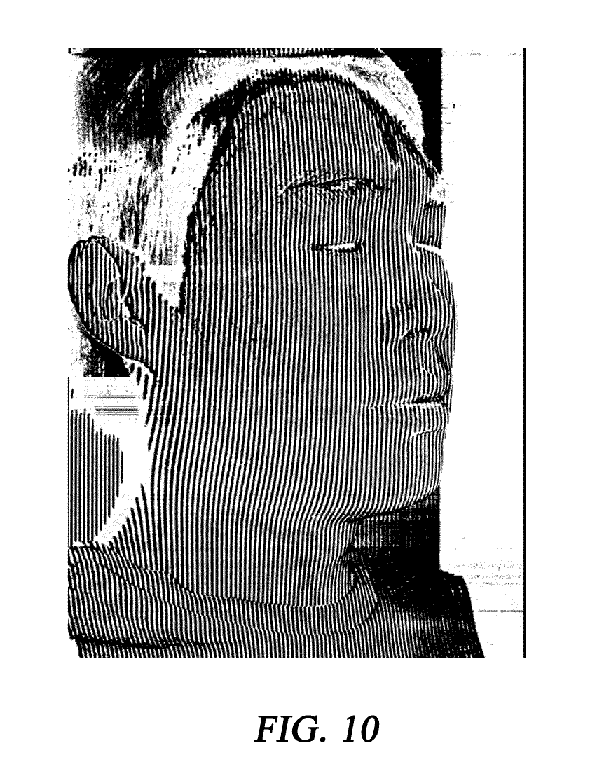

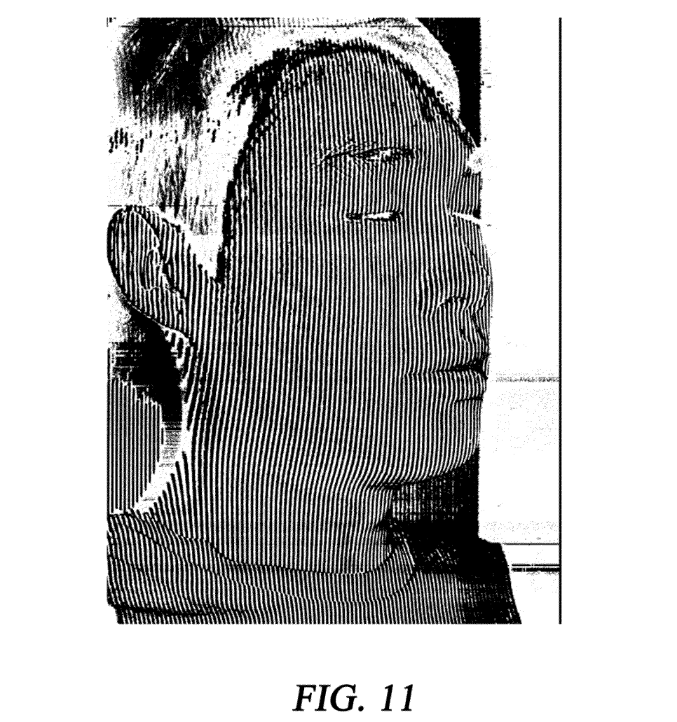

FIGS. 8 to 11 show deformed gratings acquired by using a phase shifting moire interference in tests that were conducted to validate the embodiment of the present disclosure.

The above drawings sequentially show deformed gratings when the phase difference changes to 0°, 90°, 180°, and 270° through phase shift in phase shifting moire interference.

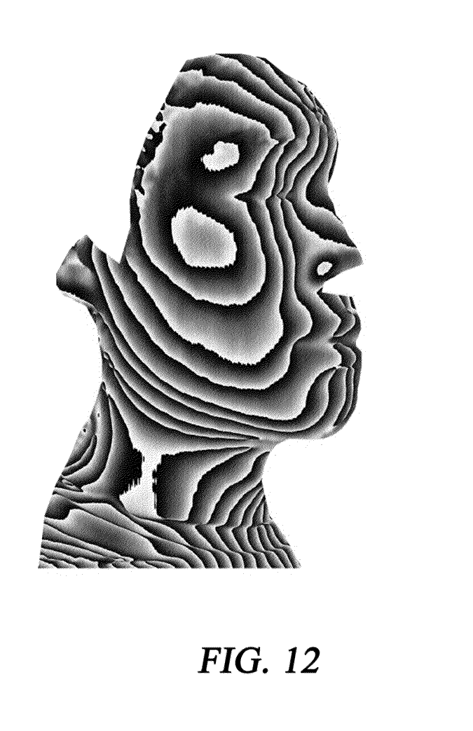

FIG. 12 shows a moire pattern generated when a deformed grating acquired by using a phase shifting moire interference in tests that were conducted to validate the embodiment was overlaid on a reference grating.

It can be seen that the 3D information of the subject of measurement was not normally acquired due to the problem of 2π ambiguity.

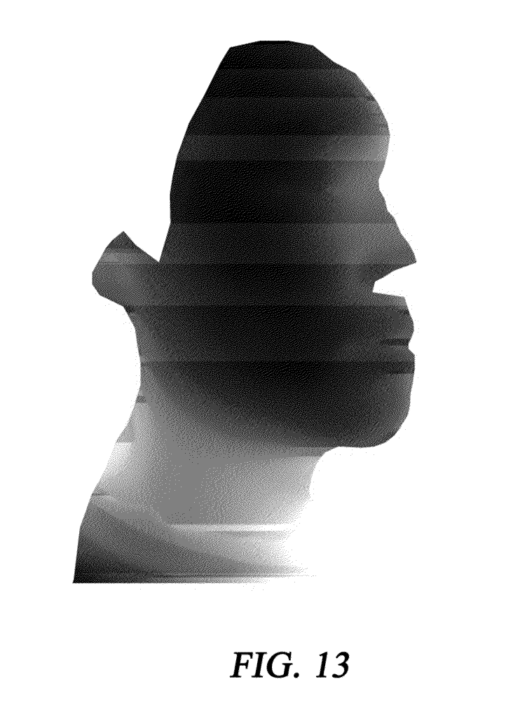

FIG. 13 shows a result obtained by differentiating the moire pattern generated by using a phase shifting moire interference in tests that were conducted to validate the embodiment along the x-axis direction.

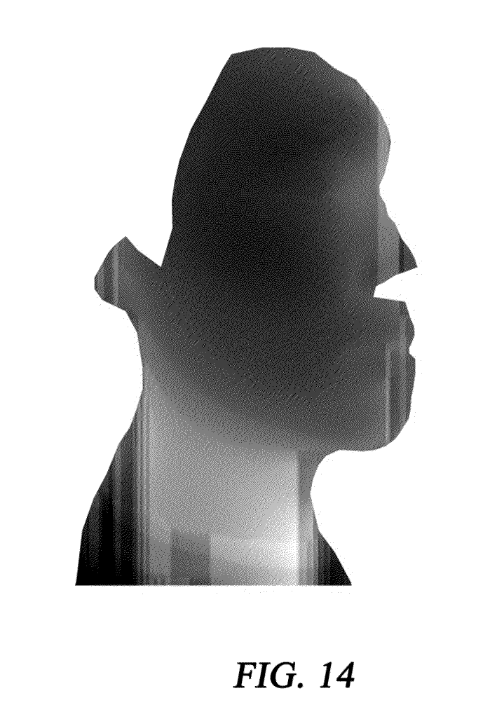

FIG. 14 shows a result obtained by differentiating the moire pattern generated by using a phase shifting moire interference in the tests that were conducted to validate the embodiment along the y-axis direction.

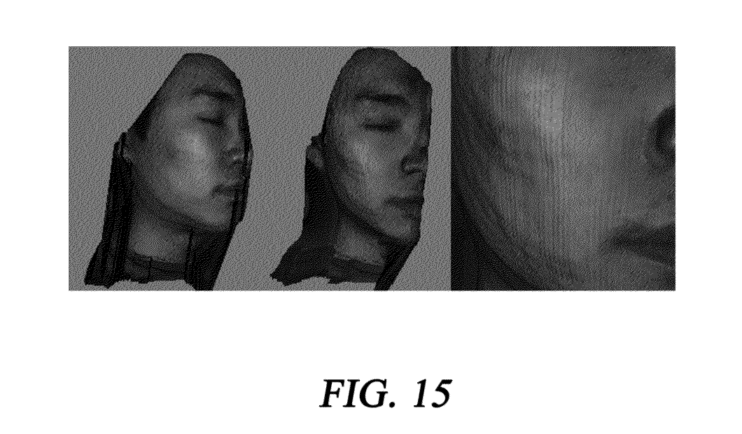

FIG. 15 shows a final 3D shape acquired by using an absolute moire order calculated by using derivative moire in the tests that were conducted to validate the embodiment.

It can be seen that by using derivative moire, the 3D information of a subject of measurement can be accurately acquired with no problem of 2π ambiguity.

Although derivative moire is applied to phase shifting moire interference in this embodiments, it is apparent to those having ordinary knowledge in the art to which the present disclosure pertains that the problem of 2π ambiguity can be overcome by using the method or apparatus of this embodiments not only in phase shifting moire interference but also in any other moire interferences.

In accordance with exemplary embodiments of the present disclosure, in 3D shape measurement using moire interference, an accurate height can be measured even there is a sharp change in height between two adjacent measuring points. Derivative moire improves the reliability of moire interference and expands the applications of moire interference throughout the overall industrial field.

Although exemplary embodiments of the present disclosure have been described for illustrative purposes, those skilled in the art will appreciate that various modifications, additions and substitutions are possible, without departing from the various characteristics of the disclosure. Therefore, exemplary embodiments of the present disclosure have been described for the sake of brevity and clarity. Accordingly, one of ordinary skill would understand the scope of the disclosure is not limited by the explicitly described above embodiments but by the claims and equivalents thereof.

What is claimed is:

1. An apparatus for measuring three-dimensional shapes by using moire interference, the apparatus comprising:
a unit calibration unit configured to use a phase difference between two adjacent measuring points for obtaining a unit calibration value of an absolute moire order;
an integrated calibration unit configured to calibrate the absolute moire order up to a target point by using unit calibration values; and
a phase calibration unit configured to calibrate a phase of the target point by using the absolute moire order.

2. The apparatus of claim 1, wherein the unit calibration unit comprises:
a unit derivative computing unit configured to compute derivative values of either of the two adjacent measuring points.

3. The apparatus of claim 2, wherein the unit derivative computing unit comprises:
a unit absolute moire order computing unit configured to calculate a unit absolute moire order by
$$u ( \frac{\partial {Φ}^{0} ( x , y )}{\partial x} {\vert}_{i , j} - {Φ}_{d} ) - u ( - \frac{\partial {Φ}^{0} ( x , y )}{\partial x} {\vert}_{i , j} - {Φ}_{d} )$$
where u(t) is a function that satisfies u(t)=1 when t≧0 or else u(t)=0, Φ⁰ is a current phase of moire pattern, and Φ_{d} (Φ_{discriminant}) is a constant to distinguish whether the absolute moire order is changing or not.

4. The apparatus of claim 1, wherein the integrated calibration unit comprises:
a first calibration unit configured to progressively calibrate the absolute moire order with respect to x-axis; and
a second calibration unit configured to progressively calibrate the absolute moire order with respect to y-axis.

5. The apparatus of claim 4, wherein the first calibration unit comprises:
a first computing unit configured to calculate the absolute moire order with respect to x-axis by
$${n}_{i , j} = {\sum }_{k = 1}^{j} [ u ( \frac{\partial {Φ}^{0} ( x , y )}{\partial x} {\vert}_{k , j} - {Φ}_{d} ) - u ( - \frac{\partial {Φ}^{0} ( x , y )}{\partial x} {\vert}_{k , j} - {Φ}_{d} ) ]$$
where u(t) is a function that satisfies u(t)=1 when t≧0 or else u(t)=0, n_{i,j} is the absolute moire order with respect to x-axis, Φ⁰ is a current phase of moire pattern, and Φ_{d} (Φ_{discriminant}) is a constant to distinguish whether the absolute moire order is changing or not.
wherein the second calibration unit comprises:
a second computing unit configured to calculate the absolute moire order with respect to y-axis by
$${n}_{i , j}^{x} = {\sum }_{k = 1}^{j} [ u ( \frac{\partial {Φ}^{0} ( x , y )}{\partial y} {\vert}_{i , k} - {Φ}_{d} ) - u ( - \frac{\partial {Φ}^{0} ( x , y )}{\partial y} {\vert}_{i , k} - {Φ}_{d} ) ]$$
where u(t) is a function that satisfies u(t)=1 when t≧0 or else u(t)=0, n_{i,j}^{x} is the absolute moire order with respect to y-axis, Φ⁰ is a current phase of moire pattern, and Φ_{d} (Φ_{discriminant}) is a constant to distinguish whether the absolute moire order is changing or not.

6. A method for measuring three-dimensional shapes by using moire interference, the method comprising:
performing a unit calibration by using a phase difference between two adjacent measuring points to obtain a unit calibration value of an absolute moire order;
performing an integrated calibration by calibrating the absolute moire order up to a target point by using unit calibration values; and
calibrating a phase of the target point by using the absolute moire order.

7. The method of claim 6, wherein the performing of the unit calibration comprises:
computing a derivative value of either of the two adjacent measuring points.

8. The method of claim 7, wherein the computing of the derivative value comprises:
calculating a unit absolute moire order by
$$u ( \frac{\partial {Φ}^{0} ( x , y )}{\partial x} {\vert}_{i , j} - {Φ}_{d} ) - u ( - \frac{\partial {Φ}^{0} ( x , y )}{\partial x} {\vert}_{i , j} - {Φ}_{d} )$$
where u(t) is a function that satisfies u(t)=1 when t≧0 or else u(t)=0, Φ⁰ is a current phase of moire pattern, and Φ_{d} (Φ_{discriminant}) is a constant to distinguish whether the absolute moire order is changing or not.

9. The method of claim 6, wherein the performing of the integrated calibration unit comprises:
performing a first calibration by progressively calibrating the absolute moire order with respect to x-axis; and
performing a second calibration by progressively calibrating the absolute moire order with respect to y-axis.

10. The method of claim 9, wherein the performing of the first calibration comprises:
performing a first computation by calculating the absolute moire order with respect to x-axis by
$${n}_{i , j} = {\sum }_{k = 1}^{j} [ u ( \frac{\partial {Φ}^{0} ( x , y )}{\partial y} {\vert}_{k , j} - {Φ}_{d} ) - u ( - \frac{\partial {Φ}^{0} ( x , y )}{\partial y} {\vert}_{k , j} - {Φ}_{d} ) ]$$
where u(t) is a function that satisfies u(t)=1 when t≧0 or else u(t)=0, n_{i,j} is the absolute moire order with respect to x-axis, Φ⁰ is a current phase of moire pattern, and Φ_{d} (Φ_{discriminant}) is a constant to distinguish whether the absolute moire order is changing or not; and
wherein the performing of the first calibration comprises:
performing a first computation by calculating the absolute moire order with respect to y-axis by
$${n}_{i , j}^{x} = {\sum }_{k = 1}^{j} [ u ( \frac{\partial {Φ}^{0} ( x , y )}{\partial y} {\vert}_{i , k} - {Φ}_{d} ) - u ( - \frac{\partial {Φ}^{0} ( x , y )}{\partial y} {\vert}_{i , k} - {Φ}_{d} ) ]$$
where u(t) is a function that satisfies u(t)=1 when t≧0 or else u(t)=0, n_{i,j}^{x} is the absolute moire order with respect to y-axis, Φ⁰ is a current phase of moire pattern, and Φ_{d} (Φ_{discriminant}) is a constant to distinguish whether the absolute moire order is changing or not.

11. A non-transitory computer readable medium storing a computer program including computer-executable instructions for causing, when executed in an electronic device with a display, the electronic device to perform the operations of claim 1.
